(19) United States
(12) Patent Application Publication
(10) Pub. No.: US 2020/0024479 A1
(43) Pub. Date: Jan. 23, 2020

(54) POLYSILAZANE-CONTAINING COMPOSITION

(71) Applicant: SHIN-ETSU CHEMICAL CO., LTD., Tokyo (JP)

(72) Inventor: Tatsuro KANEKO, Annaka-shi (JP)

(73) Assignee: SHIN-ETSU CHEMICAL CO., LTD., Tokyo (JP)

(21) Appl. No.: 16/502,548

(22) Filed: Jul. 3, 2019

(30) Foreign Application Priority Data
Jul. 18, 2018 (JP) 2018-135156

(51) Int. Cl. C09D 183/16

(52) U.S. Cl. CPC C09D 183/16

(57) ABSTRACT

A polysilazane-containing composition includes: (A) a polysilazane containing units shown by the formulae (1) and (2), the ratio of the Si—R bond to the total number of the Si—H bond and the Si—R bond being 0.01 between 0.05, inclusive; and (B) an aliphatic hydrocarbon solvent. The proportion of (A)/(B) of the components is in a mass ratio range of 0.001 or more and 1.0 or less,

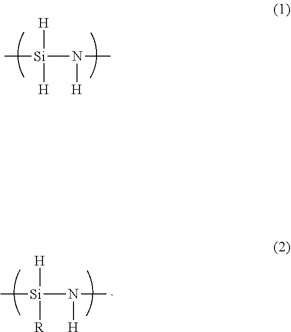

R is selected from an aliphatic hydrocarbon group having 1 to 6 carbon atoms, an aromatic hydrocarbon group having 6 to 12 carbon atoms, and an alkoxy group having 1 to 6 carbon atoms. Each R may be the same or different in one molecule of the polysilazane. The polysilazane-containing composition with the polysilazane is readily soluble in an aliphatic hydrocarbon solvent to give a cured film having the same silica glass-like properties as those of the cured film of perhydropolysilazane.

### TECHNICAL FIELD

The present invention relates to a polysilazane-containing composition.

### BACKGROUND ART

Polysilazane has been investigated for various uses as materials to form films including antifouling films for vehicles and walls of buildings, moistureproof films for semiconductor display devices such as organic EL display devices and electronic displays, together with films in devices such as semiconductor or LED devices, including layer insulation films, passivation films, protective films, and flattening films.

These films are formed by coating an appropriate base material with a coating solution containing polysilazane and a solvent to dissolve the polysilazane, followed by appropriate curing treatment to convert the polysilazane into a silicic film. In general, polysilazane resins are labile to water and oxygen, but can be protected against these materials, which promote gelation and curing, by forming a solution. In this case, polysilazane modified with an organic group has high affinity to organic solvents, and the solubility in an organic solvent is improved as the ratio of organic group is increased (see Patent Documents 1 and 2, for example).

### CITATION LIST

### Patent Literature

Patent Document 1: Japanese Patent Laid-Open Publication No. H6-116389
Patent Document 2: International Patent Laid-Open Publication No. WO 2015/163360

### Patent Document 3: Japanese Patent Laid-Open Publication No. 2004-155834

### Patent Document 4: Japanese Patent Laid-Open Publication No. 2006-515641

Patent Document 5: Japanese Patent Laid-Open Publication No. H9-157594

### SUMMARY OF INVENTION

### Technical Problem

Unlike perhydropolysilazanes, which form complete silica glass after the curing, the organopolysilazane modified with an organic group loses silica glass-like properties, which are primarily required, as the organic modification ratio increases. Accordingly, it has been necessary to select the solvent to dissolve perhydropolysilazane in order to form a silica glass film with good quality.

To dissolve perhydropolysilazane, toluene, xylene, dibutyl ether, and so on are mainly exemplified as a solvent that has been previously used. However, aromatic hydrocarbon solvents such as toluene and xylene are not necessarily safe as have been pointed out the hazard to health. Additionally, dibutyl ether forms explosive peroxide in the presence of oxygen, and care should be taken in its storage and ventilation. Moreover, the above solvents have particular odors and are unpleasant to some operators. Odors are formidable items for operators who work for a long time. If an operator inhales unpleasant odors for a long time, the operator can cause headache, dizziness, nausea, anorexia, and vomiting in some cases.

Accordingly, aliphatic hydrocarbon solvents are seems to be excellent as a safety and less-odoriferous solvent. In the aliphatic hydrocarbon solvent, however, perhydropolysilazane shows poorer solubility and is miscible to the solvent only in a very small amount, whereas a larger amount of mixing rapidly forms white turbidity and precipitation, and cannot be miscible at an optional concentration that is appropriate to the use in case of using a single solvent. Accordingly, it has been sought a solvent that can easily dissolve perhydropolysilazane and is excellent in workability and safety (see Patent Documents 3 to 5, for example).

From these reasons, it has been difficult to achieve all of silica glass-like properties as well as safety and less-odoriferousness of the solvent. To solve these issues, it has been required to develop a polysilazane-containing composition with the polysilazane being readily soluble in an aliphatic hydrocarbon solvent or any organic solvent selected in accordance with the use to give a cured film having the same properties as those of the cured film of perhydropolysilazane.

The present invention was accomplished in view of the above circumstances, and the object thereof is to provide a polysilazane-containing composition with the polysilazane being readily soluble in an aliphatic hydrocarbon solvent to give a cured film having the same silica glass-like properties as those of the cured film of perhydropolysilazane.

### Solution to Problem

To solve the problems, the present invention provides a polysilazane-containing composition comprising:

(A) a polysilazane containing a unit shown by the following formula (1) and a unit shown by the following formula (2), having an Si—H bond and an Si—R bond in a ratio of 0.01 or more and 0.05 or less with the ratio being based on the number of the Si—R bond to the total number of the Si—H bond and the Si—R bond; and

(B) an aliphatic hydrocarbon solvent;

wherein the proportion of (A)/(B) of the component (A) and the component (B) is in a range of 0.001 or more and 1.0 or less in a mass ratio,

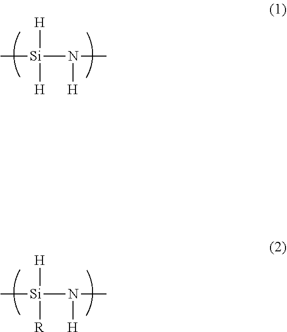

wherein R is a group selected from an aliphatic hydrocarbon group having 1 to 6 carbon atoms, an aromatic hydrocarbon group having 6 to 12 carbon atoms, and an alkoxy group having 1 to 6 carbon atoms; and each R is the same or different in one molecule of the polysilazane.

In the polysilazane-containing composition like this, the polysilazane is readily soluble in an aliphatic hydrocarbon solvent, and the cured film is allowed to have the same silica glass-like properties as those of the cured film of perhydropolysilazane.

It is preferable that R in the formula (2) be a methyl group.

The polysilazane having a methyl group as a modification group is more easily prepared.

It is preferable that the cured film of the polysilazane-containing composition with a thickness of 1 have a water vapor transmission rate of 0.05 g/(m²·day) or less at 40° C. measured by the method described in JIS K 7129:2008 Appendix A.

The polysilazane-containing composition like this is more useful because the cured product is excellent in gas barrier properties due to such a water vapor transmission rate.

### Advantageous Effects of Invention

As described above, the inventive polysilazane-containing composition employs polysilazane that is improved in solubility in an organic solvent without losing the properties of perhydropolysilazane, thereby allowing the polysilazane to be readily dissolved into any aliphatic hydrocarbon solvent and allowing the cured film to have the same silica glass-like properties as those of the cured film of perhydropolysilazane.

### DESCRIPTION OF EMBODIMENTS

As described above, it has been required to develop a polysilazane-containing composition with the polysilazane being readily soluble in an aliphatic hydrocarbon solvent to give a cured film that has the same silica glass-like properties as those of the cured film of perhydropolysilazane.

The present inventors have diligently investigated the above subjects to consequently find that the polysilazane modified in a ratio within a prescribed range is readily soluble in an aliphatic hydrocarbon solvent, and a composition of the polysilazane, together with an aliphatic hydrocarbon solvent in a prescribed ratio, forms a cured film that has the same silica glass-like properties as those of the cured film of perhydropolysilazane; thereby bringing the present invention to completion.

That is, the present invention is a polysilazane-containing composition comprising:

(A) a polysilazane containing a unit shown by the following formula (1) and a unit shown by the following formula (2), having an Si—H bond and an Si—R bond in a ratio of 0.01 or more and 0.05 or less with the ratio being based on the number of the Si—R bond to the total number of the Si—H bond and the Si—R bond; and

(B) an aliphatic hydrocarbon solvent;

wherein the proportion of (A)/(B) of the component (A) and the component (B) is in a range of 0.001 or more and 1.0 or less in a mass ratio,

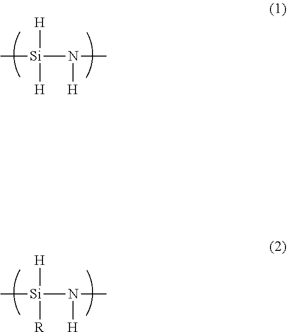

wherein R is a group selected from an aliphatic hydrocarbon group having 1 to 6 carbon atoms, an aromatic hydrocarbon group having 6 to 12 carbon atoms, and an alkoxy group having 1 to 6 carbon atoms; and each R is the same or different in one molecule of the polysilazane.

Hereinafter, the present invention will be specifically described, but the present invention is not limited thereto.

### <Polysilazane-Containing Composition>

The inventive polysilazane-containing composition is a composition that contains the component (A) and the component (B), which will be described later, as an essential components, and additives given later in accordance with needs.

### [Component (A): Polysilazane]

The polysilazane used in the present invention has the unit shown by the following formula (1) and the unit shown by the following formula (2).

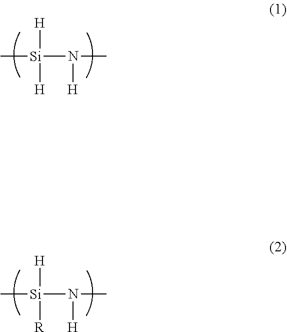

In the formula (2), R is a group selected from an aliphatic hydrocarbon group having 1 to 6, preferably 1 to 3 carbon atoms, an aromatic hydrocarbon group having 6 to 12, preferably 6 to 8 carbon atoms, and an alkoxy group having 1 to 6, preferably 1 to 3 carbon atoms; including a methyl group, an ethyl group, a phenyl group, a methoxy group, and an ethoxy group. In one polysilazane molecule, R may be appropriately selected in each repeating unit and may be the same or different.

The polysilazane in the present invention is characterized by the ratio of the Si—R bond to the Si—H bond and the Si—R bond such that the number of the Si—R bond to the total number of the Si—H bond and the Si—R bond in the formulae (1) and (2) is 0.01 or more and 0.05 or less, preferably 0.01 or more and 0.03 or less. If the ratio is less than 0.01, the solubility in an organic solvent becomes poor. If the ratio is more than 0.05, the cured film is lowered in properties compared to the silica glass film formed from perhydropolysilazane.

If the ratio of the number of the Si—R bond is 0.01 or more and 0.05 or less on the basis of the total number of the Si—H bond and the Si—R bond, the composition can be cured to form a silica glass-like cured product having the same properties as those of the cured film of perhydropolysilazane. The properties include hardness, gas barrier properties, light transmission properties, and heat resistance, for example. In general, these properties are tend to lower as the ratio of the perhydropolysilazane modified with organic groups to perhydropolysilazane increases.

In view of workability in coating, the polysilazane in the present invention preferably has a weight average molecular weight in a range of 100 to 100,000,000, more preferably 1,000 to 1,000,000, still more preferably 3,000 to 500,000 measured with tetrahydrofuran (THF) as a dissolution solvent. The weight average molecular weight of 100 or more is preferable because it is not volatile and the coating film is prevented from the risk of lowering the film properties during drying to remove the organic solvent and curing treatment. The weight average molecular weight of 100,000,000 or less is preferable because it brings sufficient solubility in an organic solvent to prevent the risk of unequal precipitation in the step of solvent drying after the coating.

It is to be noted that the weight average molecular weight in the present invention refers to a weight average molecular weight measured by gel permeation chromatography (GPC) in terms of polystyrene standard under the following conditions.

### [Measurement Conditions]

Developing solvent: tetrahydrofuran (THF)
Flow amount: 0.6 mL/min
Detector: UV detector
Column: SK Guard column Super H-L, TSK gel Super Multipore
HZ-M (4.6 mm I.D.×15 cm×4) (each of which are manufactured by Tosoh Corporation)
Column temperature: 40° C.
Sample injection amount: 20 μL (a solution in THF in concentration of 0.5 mass %)

### [Component (B): Aliphatic Hydrocarbon Solvent]

The present invention is characterized by using an aliphatic hydrocarbon solvent as a solvent for diluting the polysilazane. In the present invention, “an aliphatic hydrocarbon solvent” refers to a solvent composed of an organic compound(s) that indispensably has an aliphatic hydrocarbon group.

In general, the solvent in polysilazane-containing solutions primarily plays a role to protect the polysilazane, which is unstable to water, from water to improve the storage stability as well as a role to adjust the viscosity in order to improve the workability in coating a base material and to adjust the volatility to form a homogeneous film. Illustrative examples thereof include chain aliphatic hydrocarbons such as n-pentane, i-pentane, n-hexane, i-hexane, n-heptane, i-heptane, n-octane, i-octane, n-nonane, i-nonane, n-decane, and i-decane; and cyclic aliphatic hydrocarbons such as cyclopentane, cyclohexane, methylcyclohexane, dimetylcyclohexane, ethylcyclohexane, p-menthane, and decahydronaphtalene. These solvents may be used singly or as a mixture of a plurality of kinds and can be appropriately selected in accordance with working environment and workability. Incidentally, the aliphatic hydrocarbon solvent preferably has a purity of 95% or more, more preferably 99% or more and is allowed to contain an organic compound(s) other than the aliphatic hydrocarbon in case of satisfying this range.

In the present invention, the polysilazane of the component (A) and the aliphatic hydrocarbon solvent of the component (B) are blended such that the ratio of A/B is 0.001 or more and 1.0 or less, preferably 0.001 or more and 0.5 or less in a mass ratio. When A/B is less than 0.001, that is, when the amount of polysilazane is less than 0.1 parts by mass relative to 100 parts by mass of the aliphatic hydrocarbon solvent, the composition fails to give a coating film with sufficiently thickness when it is applied. When A/B is more than 1.0, that is, the amount of polysilazane is more than 100 parts by mass relative to 100 parts by mass of the aliphatic hydrocarbon solvent, the composition is liable to precipitate the polysilazane during the long term storage.

The polysilazane-containing solution preferably contains water in an amount of 500 ppm or less, more preferably 300 ppm or less. When the water content is 500 ppm or less, the polysilazane is prevented from reacting with water to prevent the risk of causing heat release, generation of hydrogen gas or ammonium gas, thickening, and gelation.

### [Additives]

The inventive polysilazane-containing composition may containing additives such as a catalyst and fillers in addition to the polysilazane and the organic solvent. Illustrative examples thereof include a homogeneous or heterogeneous metal catalyst containing a metal element such as magnesium, aluminum, titanium, vanadium, chromium, manganese, iron, cobalt, zinc, gallium, zirconium, niobium, palladium, and platinum; an amine catalyst including aliphatic amines such as methylamine, dimethylamine, trimethylamine, ethylamine, diethylamine, triethylamine, ethylenediamine, tetramethylethylenediamine; aliphatic aminoalcohols such as methylaminoethanol and dimethylaminoethanol; aromatic amines such as aniline, phenylethylamine, and toluidine; and heterocyclic amines such as pyrrolidine, piperidine, piperazine, pyrrole, pyrazole, imidazole, pyridine, pyridazine, pyrimidine, and pyrazine; reinforcing inorganic fillers such as fumed silica, fumed titanium dioxide, and fumed alumina; non-reinforcing inorganic fillers such as fused silica, alumina, zirconium oxide, calcium carbonate, calcium silicate, titanium dioxide, ferric oxide, and zinc oxide; adhesive aids including organosiloxane oligomer containing at least two, preferably two or three kinds of functional groups selected from an SiH group, an alkenyl group, an alkoxysilyl group and an epoxy group, an organooxysilyl-modified isocyanurate compound and hydrolysis condensate thereof, as well as silicone oils such as dimethylsilicone and phenylsilicone. They can be added in any ratio.

The inventive polysilazane-containing composition can be used for the following uses.

For example, the inventive polysilazane-containing composition can be used as a coating composition as it is. Illustrative examples of a method for applying the polysilazane-containing coating composition (polysilazane-containing composition) include a roll coating method with a chamber doctor coater, a single roll kiss coater, a reverse kiss coater, a bar coater, a reverse roll coater, a normal rotation roll coater, a blade coater, or a knife coater; a spin coating method, a dispensing method, a dipping method, a spraying method, a transferring method, and a slit coating method.

Illustrative examples of a base material to be coated include a silicon substrate, a glass substrate, a metal substrate, a resin substrate, and a resin film. It is also possible to apply the composition to a substrate provided with a circuit or a semiconductor film in the process of forming a semiconductor device if it is necessary. The thickness of coating film differs based on the object of using the film, and is generally 10 to 100,000 nm, preferably 100 to 1,000 nm in thickness of the cured film.

After applying the coating composition to form a polysilazane resin coating film as described above, it is preferable to perform heat drying treatment in order to cure the coating film. This step intends to completely remove the solvent contained in the coating film and to perform curing reaction to promote changing reaction of the polysilazane to a polysiloxane bond.

The temperature for heat drying is usually in a range of the room temperature (25° C.) to 300° C., preferably 70° C. to 200° C. Illustrative examples of preferable treating method in the heat drying step include heat treatment, steam heating treatment, atmospheric pressure plasma treatment, low temperature plasma treatment, UV treatment, and excimer treatment. Each of them is selected based on the combination of a substrate and a film corresponding thereto.

### EXAMPLES

Hereinafter, the present invention will be specifically described using Examples and Comparative Examples, but the present invention is not limited thereto. Incidentally, the parts in the following Examples indicates parts by mass.

### Example 1

Into 300 ml of dehydrated pyridine at −10° C., 0.189 mol of dichlorosilane with a purity of 99% or more and 0.004 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 5,225.

### Example 2

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 1,583.

### Example 3

Into 300 ml of dehydrated pyridine at −10° C., 0.189 mol of dichlorosilane with a purity of 99% or more and 0.02 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 1,582.

### Example 4

Into 300 ml of dehydrated pyridine at −10° C., 0.189 mol of dichlorosilane with a purity of 99% or more and 0.01 mol of phenyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 1,620.

### Example 5

Into 300 ml of dehydrated pyridine at −10° C., 0.189 mol of dichlorosilane with a purity of 99% or more, 0.004 mol of methyldichlorosilane, and 0.004 mol of phenyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 1,784.

### Example 6

Into 300 ml of dehydrated pyridine at −10° C., 0.190 mol of dichlorosilane with a purity of 99% or more was blown with stirring, together with nitrogen gas. Subsequently, 0.57 mol of ammonia with a purity of 99% or more was blown thereinto, and the formed salt was removed by pressure filtration to give a polysilazane solution. To this polysilazane solution, 0.01 mol of ethanol was added to react with the polysilazane, and this was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 1,567.

### Example 7

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of an aliphatic hydrocarbon solvent EXXSOL D40 (manufactured by Exxon Mobile Corporation) was added to remove the pyridine by azeotropic distillation, and EXXSOL D40 was added so as to set the mass ratio of polysilazane/EXXSOL D40 to 0.05 when the whole solution was set to 100 parts, thereby giving a polysilazane-containing composition. The obtained polysilazane had a weight average molecular weight of 1,833.

### Example 8

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of cyclohexane was added to remove the pyridine by azeotropic distillation, and cyclohexane was added so as to set the mass ratio of polysilazane/cyclohexane to 0.05 when the whole solution was set to 100 parts, thereby giving a polysilazane-containing composition. The obtained polysilazane had a weight average molecular weight of 1,777.

### Example 9

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.001 when the whole solution was set to 100 parts, thereby giving a polysilazane-containing composition. The obtained polysilazane had a weight average molecular weight of 1,489.

### Example 10

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 1.0 when the whole solution was set to 100 parts, thereby giving a polysilazane-containing composition. The obtained polysilazane had a weight average molecular weight of 1,564.

### Example 11

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane and dimethylsilicone with a kinematic viscosity of 50 mm²/s (trade name: KF-96-50CS, manufactured by Shin-Etsu Chemical Co., Ltd.) were added so as to set the mass ratio of polysilazane/n-octane to 0.06 and the amount of dimethylsilicone to 5 parts when the whole solution was set to 100 parts, thereby giving a polysilazane-containing composition. The obtained polysilazane had a weight average molecular weight of 1,821.

### Example 12

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane and palladium propionate were added so as to set the mass ratio of polysilazane/n-octane to 0.05 and the amount of palladium propionate to 0.05 parts when the whole solution was set to 100 parts, thereby giving a polysilazane-containing composition. The obtained polysilazane had a weight average molecular weight of 1,812.

### Comparative Example 1

Into 300 ml of dehydrated pyridine at −10° C., 0.190 mol of dichlorosilane with a purity of 99% or more was blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 7,458.

### Comparative Example 2

Into 300 ml of dehydrated pyridine at −10° C., 0.189 mol of dichlorosilane with a purity of 99% or more and 0.002 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 5,420.

### Comparative Example 3

Into 300 ml of dehydrated pyridine at −10° C., 0.189 mol of dichlorosilane with a purity of 99% or more and 0.04 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.05 when the whole solution was set to 100 parts, thereby giving a polysilazane-containing composition. The obtained polysilazane had a weight average molecular weight of 3,855.

### Comparative Example 4

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 0.0005 when the whole solution was set to 100 parts, thereby giving a polysilazane-containing composition. The obtained polysilazane had a weight average molecular weight of 1,549.

### Comparative Example 5

Into 300 ml of dehydrated pyridine at −10° C., 0.189 mol of dichlorosilane with a purity of 99% or more and 0.01 mol of methyldichlorosilane were blown with stirring, together with nitrogen gas. Subsequently, 0.57 mol of ammonia with a purity of 99% or more was blown thereinto, and the formed salt was removed by pressure filtration to give a polysilazane solution. This polysilazane solution was heated to 150° C. to distill off 150 ml of the pyridine. Then, 300 ml of n-octane was added to remove the pyridine by azeotropic distillation, and n-octane was added so as to set the mass ratio of polysilazane/n-octane to 1.5 when the whole solution was set to 100 parts, thereby giving a polysilazane-containing composition. The obtained polysilazane had a weight average molecular weight of 1,603.

### Reference Example

In the same manner as in Comparative Example 1 except for changing n-octane to dibutyl ether, a perhydropolysilazane-containing composition was prepared.

On each composition obtained in Examples 1 to 12, Comparative Examples 1 to 5, and Reference Example described above, the following evaluations were performed.

### Appearance

Each obtained composition was observed visually to evaluate whether the polysilazane had been fully dissolved.

### Water Vapor Transmission Rate

The water vapor transmission rate was measured at 40° C. by the method described in JIS K 7129:2008 Appendix A using a water vapor transmission rate measurement apparatus Lyssy L80-5000 (manufactured by Systech Instruments Ltd.). The measurement sample was prepared by applying each composition onto a polyimide film having a water vapor transmission rate of 100 g/(m²·day) using a spin coater so as to have a coating film with a thickness of 1.0 μm, followed by heat curing at 150° C. for 48 hours.

### Pencil Hardness Test

The pencil hardness was measured by using a pencil hardness tester (manufactured by Pepaless Co., Ltd.). The measurement sample was prepared by applying each composition onto a test piece made of SUS 430 using a spin coater so as to have a coating film with a thickness of 1.0 followed by heat curing at 150° C. for 48 hours.

Table 1 shows the results of Examples, Comparative Examples, and Reference Example.

TABLE 1

| | (A) polysilazane | | | | | | Water | |
|---|---|---|---|---|---|---|---|---|
| | | Modification | | | | | vapor | |
| | | ratio | | | | | transmission | |
| | Modification | [SiR/(SiH + | (B) Solvent | (A)/(B) | | | rate | Pencil |
| | group | SiR)] | type | ratio | Additive | Appearance | [g/(m² · day)] | hardness |
| Reference | — | — | dibutyl | 0.05 | — | Colorless | <0.05 | 8H |
| Example | | | ether | | | transparent | | |
| Example 1 | Methyl | 0.01 | octane | 0.05 | — | Colorless | <0.05 | 8H |
| | | | | | | transparent | | |
| Example 2 | Methyl | 0.025 | octane | 0.05 | — | Colorless | <0.05 | 8H |
| | | | | | | transparent | | |
| Example 3 | Methyl | 0.05 | octane | 0.05 | — | Colorless | <0.05 | 8H |
| | | | | | | transparent | | |
| Example 4 | Phenyl | 0.025 | octane | 0.05 | — | Colorless | <0.05 | 8H |
| | | | | | | transparent | | |
| Example 5 | Methyl, | 0.01 + | octane | 0.05 | — | Colorless | <0.05 | 8H |
| | Phenyl | 0.01 | | | | transparent | | |
| Example 6 | Ethyl | 0.025 | octane | 0.05 | — | Colorless | <0.05 | 8H |
| | | | | | | transparent | | |
| Example 7 | Methyl | 0.025 | EXXSOL D40 | 0.05 | — | Colorless | <0.05 | 8H |
| | | | | | | transparent | | |
| Example 8 | Methyl | 0.025 | cyclo- | 0.05 | — | Colorless | <0.05 | 8H |
| | | | hexane | | | transparent | | |
| Example 9 | Methyl | 0.025 | octane | 0.001 | — | Colorless | <0.05 | 8H |
| | | | | | | transparent | | |
| Example 10 | Methyl | 0.025 | octane | 1.0 | — | Colorless | <0.05 | 8H |
| | | | | | | transparent | | |
| Example 11 | Methyl | 0.025 | octane | 0.06 | Dimethyl- | Colorless | <0.05 | 8H |
| | | | | | silicone | transparent | | |
| Example 12 | Methyl | 0.025 | octane | 0.05 | Palladium | Brown | <0.05 | 8H |
| | | | | | propionate | transparent | | |
| Comparative | — | — | octane | 0.05 | — | White | Failed to | Failed to |
| Example 1 | | | | | | turbid | form a film | form a film |
| Comparative | Methyl | 0.005 | octane | 0.05 | — | White | Failed to | Failed to |
| Example 2 | | | | | | turbid | form a film | form a film |
| Comparative | Methyl | 0.1 | octane | 0.05 | — | Colorless | 0.1 | 7H |
| Example 3 | | | | | | transparent | | |
| Comparative | Methyl | 0.025 | octane | 0.0005 | — | Colorless | 1.5 | 8H |
| Example 4 | | | | | | transparent | | |
| Comparative | Methyl | 0.025 | octane | 1.5 | — | Slightly | <0.05 | Failed to |
| Example 5 | | | | | | turbid | | form a film |

As shown in Table 1, in Examples 1 to 12 of the inventive polysilazane-containing composition, polysilazane was fully dissolved in the aliphatic hydrocarbon solvent, and the obtained cured film had silica glass-like properties that were the same as those of the cured film of perhydropolysilazane (Reference Example).

On the other hand, in Comparative Example 1 using organic-unmodified polysilazane (perhydropolysilazane) and Comparative Example 2 using polysilazane that had organic modification ratio lower than the range of the present invention, each polysilazane was not dissolved into the aliphatic hydrocarbon solvent. In Comparative Example 3 using polysilazane that had organic modification ratio higher than the range of the present invention, the polysilazane was dissolved into octane, but the water vapor transmission rate and the pencil hardness were inferior to those of Examples and Reference Example. Additionally, Example 4 and Example 5, in which the ratio of the component (A) and the component (B) did not fulfill the present invention, showed inferior results compared to those of Examples.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

1. A polysilazane-containing composition comprising:
(A) a polysilazane containing a unit shown by the following formula (1) and a unit shown by the following formula (2), having an Si—H bond and an Si—R bond in a ratio of 0.01 or more and 0.05 or less with the ratio being based on the number of the Si—R bond to the total number of the Si—H bond and the Si—R bond; and
(B) an aliphatic hydrocarbon solvent;
wherein the proportion of (A)/(B) of the component (A) and the component (B) is in a range of 0.001 or more and 1.0 or less in a mass ratio, 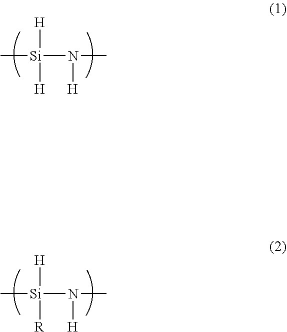
wherein R is a group selected from an aliphatic hydrocarbon group having 1 to 6 carbon atoms, an aromatic hydrocarbon group having 6 to 12 carbon atoms, and an alkoxy group having 1 to 6 carbon atoms; and each R is the same or different in one molecule of the polysilazane.

2. The polysilazane-containing composition according to claim 1, wherein R in the formula (2) is a methyl group.

3. The polysilazane-containing composition according to claim 1, wherein the cured film of the polysilazane-containing composition with a thickness of 1 μm has a water vapor transmission rate of 0.05 g/(m²·day) or less at 40° C. measured by the method described in JIS K 7129:2008 Appendix A.

4. The polysilazane-containing composition according to claim 2, wherein the cured film of the polysilazane-containing composition with a thickness of 1 μm has a water vapor transmission rate of 0.05 g/(m²·day) or less at 40° C. measured by the method described in JIS K 7129:2008 Appendix A.
